(19) United States
(12) Patent Application Publication
(10) Pub. No.: US 2026/0116098 A1
(43) Pub. Date: Apr. 30, 2026

(54) IMAGE FORMING APPARATUS

(71) Applicant: CANON KABUSHIKI KAISHA, Tokyo (JP)

(72) Inventor: EIKOU MORI, Tokyo (JP)

(21) Appl. No.: 19/371,307

(22) Filed: Oct. 28, 2025

(30) Foreign Application Priority Data
Oct. 31, 2024 (JP) 2024-191567

(51) Int. Cl. B41J 11/20; B41J 11/00

(52) U.S. Cl. CPC B41J 11/20; B41J 11/007; B41J 11/0085

(57) ABSTRACT

An image forming apparatus includes a belt configured to convey a sheet along a conveyance plane, a recording head having an ejection plane at which ink is ejected, a movable member configured to be movable in a first direction such that the belt is moved closer to and farther from the recording head, a first adjusting member configured to adjust a distance in the first direction between the ejection plane and the conveyance plane, and a second adjusting member disposed on the movable member, wherein the first adjusting member is configured to move such that the first adjusting member and the second adjusting member abut against each other an abutment position, and wherein the second adjusting member is configured to adjust the distance in the first direction by changing a position of the movable member in the first direction with respect to the abutment position.

### BACKGROUND

### Field of the Technology

The present disclosure relates to an image forming apparatus that forms images on sheets.

### Description of the Related Art

Japanese Patent Application Publication No. 2009-285952 describes an ink-jet image forming apparatus in which a gap adjusting mechanism operates in a case where a platen that supports a conveyance belt is moved back and forth with respect to a recording head in the thickness direction of sheets, so that the gap between the recording head and the conveyance belt changes. In addition, Japanese Patent Application Publication No. 2020-157574 describes another ink-jet image forming apparatus in which a plurality of recording heads is moved individually with respect to a platen that supports a conveyance belt, so that the gap between an individual recording head and the platen is adjusted.

### SUMMARY

The present disclosure provides a new technique related to adjustment of a gap between recording head and a belt.

An aspect of the present disclosure provides an image forming apparatus including a belt configured to convey a sheet along a conveyance plane formed by a portion of an outer circumferential surface of the belt, a recording head disposed to face the belt, the recording head having an ejection plane at which ink is ejected from the recording head toward the sheet being conveyed by the belt, a movable member configured to be movable in a first direction such that the belt is moved closer to and farther from the recording head, a first adjusting member configured to adjust a distance in the first direction between the ejection plane and the conveyance plane at a position where the belt faces the ejection plane by moving the movable member in the first direction, and a second adjusting member disposed on the movable member, arranged to abut against the first adjusting member, wherein the first adjusting member is configured to move such that the first adjusting member and the second adjusting member abut against each other an abutment position, and wherein the second adjusting member is configured to adjust the distance in the first direction by changing a position of the movable member in the first direction with respect to the abutment position.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system that includes an image forming apparatus of the present embodiment.

FIG. 2 is a schematic diagram illustrating a print belt unit.

FIG. 3 is a perspective view illustrating a pressure chamber and a negative-pressure generating unit.

FIG. 4 is a schematic diagram illustrating the pressure chamber and a print-belt-unit frame.

FIG. 5 is a perspective view illustrating a state where a single recording head is fixed to the pressure chamber.

FIG. 6 is a perspective view illustrating a print-gap adjusting mechanism.

FIG. 7 is a block diagram illustrating a control system of the print-gap adjusting mechanism.

FIG. 8A is a side view illustrating a manual adjusting cam that is in contact with an automatic adjusting cam at a scale mark of 5.

FIG. 8B is a side view illustrating the manual adjusting cam that is in contact with the automatic adjusting cam at a scale mark of 8.

FIG. 9A is a side view illustrating a state where the pressure chamber is most distant from the recording head by the automatic adjusting cam.

FIG. 9B is a side view illustrating a state where the pressure chamber is moved closest to the recording head by the automatic adjusting cam.

FIG. 10A is a side view illustrating another embodiment of the manual adjusting cam in a state where the pressure chamber is most distant from the recording head by the automatic adjusting cam.

FIG. 10B is a side view illustrating the other embodiment of the manual adjusting cam in a state where the pressure chamber is moved closest to the recording head by the automatic adjusting cam.

### DESCRIPTION OF THE EMBODIMENTS

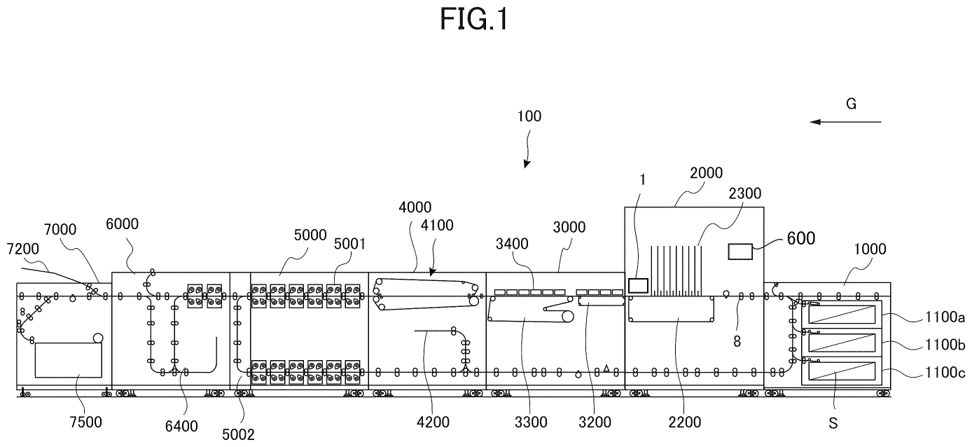

Hereinafter, embodiment(s) of the present disclosure will be described with reference to the accompanying drawings. First, an image forming system that includes an image forming apparatus of the present embodiment will be described with reference to FIG. 1. An image forming system 100 illustrated in FIG. 1 is a so-called sheet-fed printing machine that forms an image on a sheet S by using ink and reaction liquid. For example, the image forming system 100 is used in the commercial/industrial printing field. The sheet S may be any sheet as long as the sheet can accept the ink. For example, the sheet S may be a paper sheet, such as a regular paper sheet or a thick paper sheet, a plastic film such as an overhead projector sheet, or a cloth sheet.

As illustrated in FIG. 1, the image forming system 100 includes a feeding module 1000, a print module 2000, a drying module 3000, a fixing module 4000, a cooling module 5000, a reversing module 6000, and a stacking module 7000. The sheet S on which an image is to be formed is fed from the feeding module 1000, subjected to various processes when conveyed along the conveyance path in the above-described modules, and finally discharged to the stacking module 7000.

The feeding module 1000 includes a plurality of (three in the present embodiment) cassettes 1100a, 1100b, and 1100c. Each of the cassettes 1100a to 1100c can store the sheet S. Each of the cassettes 1100a to 1100c can be drawn toward the front side of the apparatus for storing the sheet S. The feeding module 1000 conveys the sheet S, one by one, from any one of the cassettes 1100a to 1100c to the print module 2000. Thus, each of the cassettes 1100a to 1100c includes a separation belt and a conveyance roller. Note that since the above-described number of the cassettes 1100a to 1100c is one example, the feeding module 1000 may include one, two, or four or more cassettes.

The print module 2000 is an ink-jet image forming apparatus (i.e., an ink-jet recording apparatus) that forms an image on a sheet by ejecting ink onto the sheet fed from the feeding module 1000 and conveyed. The print module 2000 includes a pre-formation registration correction portion 8, a print belt unit 2200, a recording portion 2300, and a control portion 600. The pre-formation registration correction portion 8 corrects the skew and position of the sheet fed from the feeding module 1000, and conveys the sheet to the print belt unit 2200.

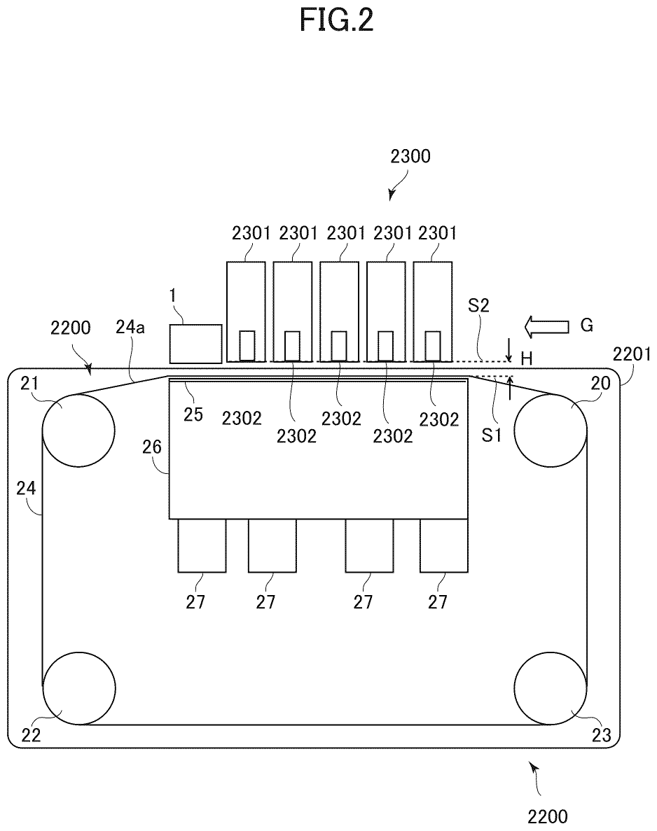

The print belt unit 2200 and the recording portion 2300 are disposed downstream of the pre-formation registration correction portion 8 in a conveyance direction (indicated by an arrow G) of the sheet S, so as to face each other via the conveyance path of the sheet S. The print belt unit 2200 conveys the sheet S conveyed from the pre-formation registration correction portion 8, while sucking the sheet S. The recording portion 2300 forms an image on the sheet S conveyed by the print belt unit 2200, by causing a plurality of recording heads 2301 (see FIG. 2) to eject ink onto the sheet S from above the sheet S. Since the sheet S is conveyed by the print belt unit 2200 while sucked by the print belt unit 2200, the clearance between the plurality of recording heads 2301 and the sheet S is substantially kept.

As illustrated in FIG. 2, the plurality of recording heads 2301 is disposed side by side along the conveyance direction of the sheet S, so as to face a conveyance belt 24. The recording heads 2301 of the present embodiment are five line-type recording heads that correspond to a reaction liquid in addition to four colors of Y (yellow), M (magenta), C (cyan), and K (black). Each of the recording heads 2301 includes an ejection portion 2302 (referred to also as a nozzle) that ejects ink onto the sheet S conveyed by the conveyance belt 24. The ink is ejected from an ejection plane S2 of the ejection portion 2302. Note that the number of colors and the number of the recording heads 2301 are not limited to five. In addition, the ink-jet system used may be a system that uses a heater element, a system that uses a piezoelectric element, a system that uses an electrostatic element, or a system that uses a MEMS element. The ink of each color is supplied to a corresponding recording head 2301 from an ink tank (not illustrated), via a corresponding ink tube.

An image reading apparatus 1 that is an inline scanner is disposed downstream of the recording portion 2300 in the conveyance direction, so as to face the print belt unit 2200. The image reading apparatus 1 detects the deviation and color density of an image formed on the sheet S conveyed to the print belt unit 2200. The result detected by the image reading apparatus 1 is used for correcting an image to be formed on a following sheet S by the recording portion 2300.

Referring back to FIG. 1, the sheet S on which an image has been formed by the recording portion 2300 is conveyed to the drying module 3000 by the print belt unit 2200. The drying module 3000 dries the sheet S on which an image has been formed by the print module 2000. The drying module 3000 increases the fixability between the sheet S and the ink by reducing the liquid component contained in the ink, by drying the sheet S. The drying module 3000 includes a decoupling portion 3200, a drying belt unit 3300, and a warm-air blowing portion 3400.

The sheet S on which an image has been formed is conveyed to the decoupling portion 3200 of the drying module 3000. The decoupling portion 3200 conveys the sheet S while holding the sheet S, by using the wind pressure of the wind blown on the sheet S from above, and the frictional force between the sheet S and the belt. With this operation, a portion of the sheet S left in the print belt unit 2200 in a state where the sheet S is passing across the boundary between the print belt unit 2200 and the decoupling portion 3200 is prevented from being deviated.

While the sheet S conveyed from the decoupling portion 3200 is sucked and conveyed by the drying belt unit 3300, hot air is blown on the sheet S, from the warm-air blowing portion 3400 disposed above the belt. With this operation, an image-formed surface (i.e., a surface applied with ink) of the sheet S, on which an image has been formed by the print module 2000 by applying the ink, is dried. Note that as the drying system of the drying module 3000, a system that emits electromagnetic wave (such as ultraviolet rays or infrared rays) to the surface of the sheet S, a heat transfer system that causes a heating element to contact the sheet S, or a system in which the above-described systems are combined with each other may be used, instead of the system that blows the hot air on the sheet S.

The fixing module 4000 fixes the image to the sheet S by drying the ink by heating the sheet S dried by the drying module 3000. The fixing module 4000 includes a fixing-belt unit 4100 that includes an upper belt unit and a lower belt unit. The fixing module 4000 fixes the ink to the sheet S conveyed from the drying module 3000, by causing the sheet S to pass through between the upper belt unit and the lower belt unit that are heated.

The cooling module 5000 solidifies the ink softened by the heating, by cooling the sheet S to which the image has been fixed by the fixing module 4000; and reduces the change in temperature of the sheet S caused by the apparatuses disposed downstream of the cooling module 5000. The cooling module 5000 includes a plurality of cooling portions 5001. The plurality of cooling portions 5001 cools the high-temperature sheet S conveyed from the fixing module 4000. For example, each of the plurality of cooling portions 5001 cools the sheet S by increasing the pressure of a corresponding cooling box by taking the external air in the cooling box by using a fan, and by causing the pressure of the cooling box to blow the wind, ejected from a nozzle formed in a conveyance guide, on the sheet S. The plurality of cooling portions 5001 is disposed on both sides of the conveyance path of the sheet S, and can cool both sides of the sheet S.

The cooling module 5000 includes a conveyance-path switch portion 5002. The conveyance-path switch portion 5002 switches the conveyance path of the sheet S between a path for conveying the sheet S to the reversing module 6000, and a duplex conveyance path through which the sheet S is conveyed in the double-side printing.

In the double-side printing, the sheet S is conveyed to a conveyance path disposed in a lower portion of the cooling module 5000, by the conveyance-path switch portion 5002. After that, the sheet S is conveyed through a duplex conveyance path of each of the fixing module 4000, the drying module 3000, the print module 2000, and the feeding module 1000. In a duplex conveyance portion of the fixing module 4000, a first reversing portion 4200 that reverses the front side and the back side of the sheet S is disposed. After the sheet S is conveyed to the first reversing portion 4200, the sheet S is reversed and conveyed to the drying module 3000, so that the front side and the back side of the sheet S are reversed. Since the sheet S passes through the first reversing portion 4200, an image can be formed on the back side of the sheet S. Then the sheet S is conveyed again to the pre-formation registration correction portion 8, the print belt unit 2200, and the recording portion 2300 of the print module 2000, so that an image is formed on the sheet S.

The reversing module 6000 includes a second reversing portion 6400. In the reversing module 6000, the front side and the back side of the sheet S conveyed can be reversed by the second reversing portion 6400. With this operation, the orientation of the front side and the back side of the sheet S to be conveyed to the stacking module 7000 can be changed. The stacking module 7000 includes a top tray 7200 and a stacking portion 7500; and sorts the sheet S conveyed from the reversing module 6000, into the top tray 7200 or the stacking portion 7500, and stacks the sheet S on the top tray 7200 or the stacking portion 7500.

### Print Belt Unit

Next, a configuration of the print belt unit 2200 will be described with reference to FIGS. 2 to 5. As illustrated in FIG. 2, the print belt unit 2200 includes a print-belt-unit frame 2201, a plurality of (four in the present embodiment) stretching rollers 20, 21, 22, and 23 supported by the print-belt-unit frame 2201, and the endless conveyance belt 24 stretched around the stretching rollers 20 to 23. The print-belt-unit frame 2201 supports the stretching rollers 20 to 23 such that both shaft ends of each of the stretching rollers 20 to 23 are supported by both wall portions of the print-belt-unit frame 2201 formed on the front side and the back side, in FIG. 2, in the width direction that intersects the conveyance direction (indicated by an arrow G) of the sheet S.

At least one of the stretching rollers 20 to 23 functions as a driving roller, and rotates the conveyance belt 24. Since the conveyance belt 24 rotates, the sheet S is conveyed in the conveyance direction. In addition, at least one of the stretching rollers 20 to 23 except for the driving roller functions as a tension roller, and applies predetermined tension to the conveyance belt 24. Since the predetermined tension is applied to the conveyance belt 24, the conveyance belt 24 can rotate without being bent.

The sheet S is conveyed while borne by an outer circumferential surface 24a of the conveyance belt 24. In the present embodiment, the sheet S is attracted and sucked onto a portion of the conveyance belt 24 stretched between the stretching rollers 20 and 21. In the conveyance belt 24, a plurality of attracting holes is formed for attracting the sheet S. Since the sheet S is attracted and sucked by the conveyance belt 24, the behavior in conveyance of the sheet S becomes stable. Since the behavior in conveyance of the sheet S conveyed by the conveyance belt 24 becomes stable, an image is stably formed on the sheet S by ejecting ink from the plurality of recording heads 2301.

The print belt unit 2200 includes a pressure chamber 26 disposed at a position that faces the recording heads 2301 in the vertical direction, via the conveyance belt 24 that conveys the sheet S. The pressure chamber 26 includes a platen 25 in which a plurality of holes is formed. The platen 25 is disposed inside with respect to the conveyance belt 24 and positioned at a position that faces the recording heads 2301, for forming a conveyance plane S1 in one portion of the outer circumferential surface 24a of the conveyance belt 24. The conveyance plane S1 is a plane for sucking and conveying the sheet S. In addition, a plurality of negative-pressure generating units 27 that generates negative pressure in the pressure chamber 26 is connected to the pressure chamber 26.

The pressure chamber 26 and the plurality of negative-pressure generating units 27 constitute a sucking unit that causes the conveyance belt 24 to suck the sheet S, and are disposed in the print-belt-unit frame 2201. In the present embodiment, the pressure chamber 26 that serves as a movable member is disposed so as to be able to move vertically (in a first direction) in the print-belt-unit frame 2201 (i.e., the frame) to which the plurality of negative-pressure generating units 27 is fixed. In addition, for a worker to manually move the pressure chamber 26 when assembling the print module 2000, manual adjusting cams 28 are rotatably disposed at a plurality of (e.g., four) positions positioned outside the side wall portions of the pressure chamber 26 in the width direction. As described below, in the present embodiment, since the manual adjusting cam 28 is operated when the print module 2000 is assembled, the distance between the ejection plane S2 of the ejection portion 2302 and the plane formed by the outer circumferential surface 24a of the conveyance belt 24 at a position at which the outer circumferential surface 24a faces the ejection plane S2, that is, the distance between the ejection plane S2 and the conveyance plane S1 can be adjusted into a predetermined distance (e.g., 1.38 mm).

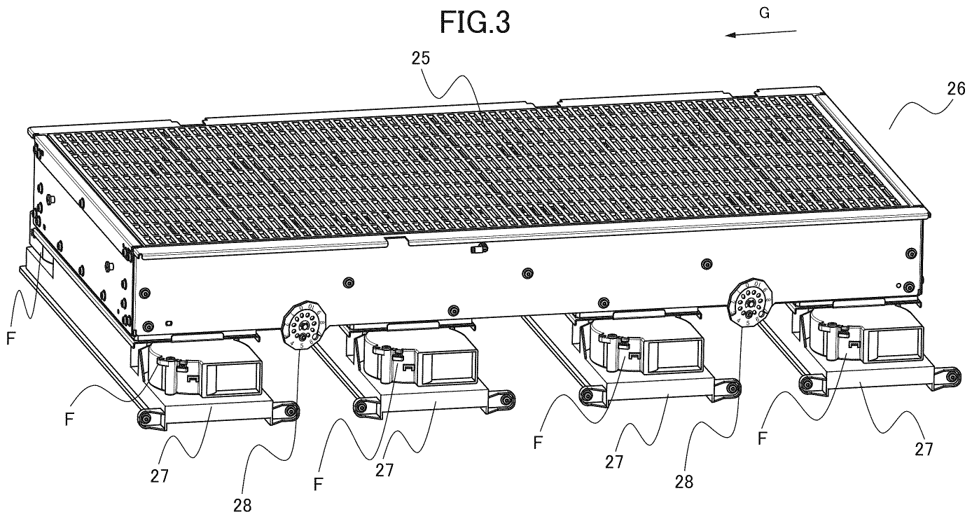

As illustrated in FIG. 3, each of the plurality of negative-pressure generating units 27 includes a fan F. The fan F discharges the air contained in a corresponding negative-pressure generating unit 27. With this operation, the negative pressure is generated in the interior of the negative-pressure generating unit 27. The interior of the plurality of negative-pressure generating units 27 communicates with the interior of the pressure chamber 26. Thus, if the interior of the plurality of negative-pressure generating units 27 has the negative pressure, the interior of the pressure chamber 26 also has the negative pressure. If the interior of the pressure chamber 26 has the negative pressure, the attracting force is generated in the attracting holes formed in the conveyance belt 24, via the holes of the platen 25 disposed in an upper portion of the pressure chamber 26. Thus, the sheet S is sucked by the conveyance belt 24, by the attracting force generated in the attracting holes of the conveyance belt 24.

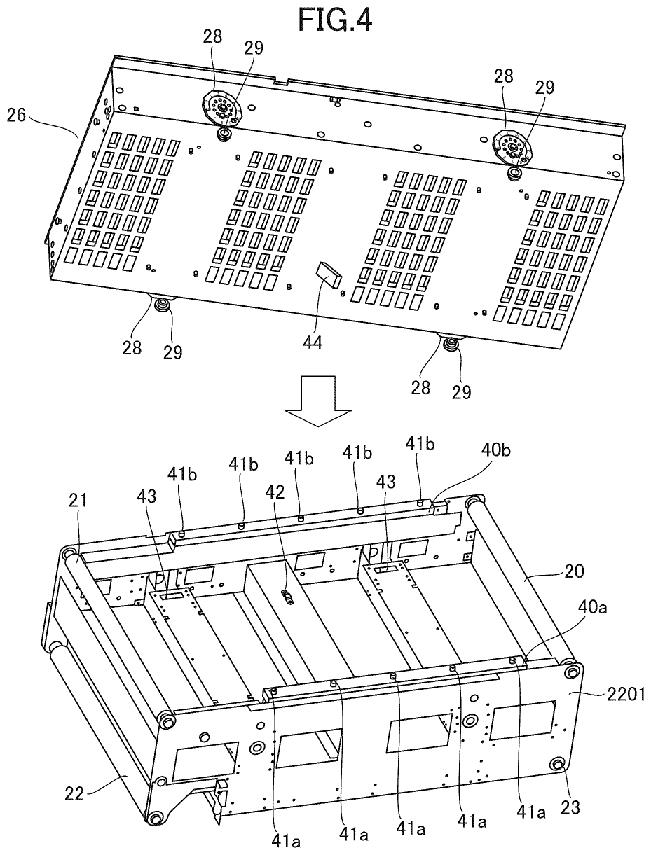

As illustrated in FIG. 4, two recording-portion holding members 40a and 40b are disposed in the print-belt-unit frame 2201 that supports the shafts of the stretching rollers 20 to 23. Specifically, the recording-portion holding members 40a and 40b face each other in the width direction, via the pressure chamber 26; and are disposed on upper edges of both wall portions of the print-belt-unit frame 2201. The recording-portion holding members 40a and 40b respectively include head fixing portions 41a and 41b for fixing the plurality of recording heads 2301. In the present embodiment, the recording-portion holding member 40a includes five head fixing portions 41a that correspond to the five recording heads 2301, and the recording-portion holding member 40b includes five head fixing portions 41b that correspond to the five recording heads 2301. Note that in FIG. 4, the below-described automatic adjusting cam 29 is illustrated conveniently and the negative-pressure generating units 27 are omitted.

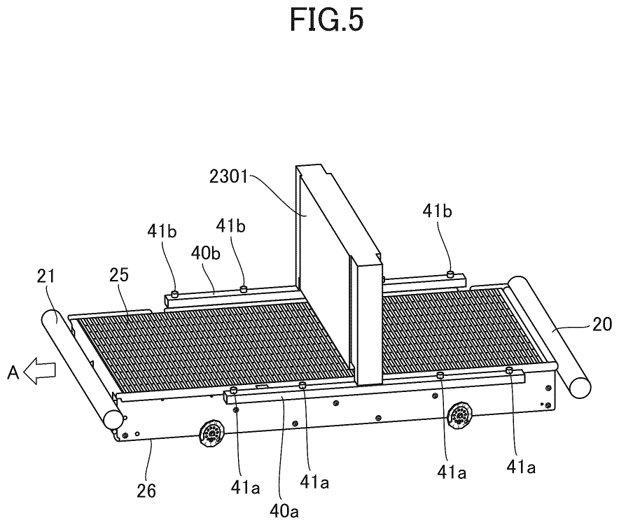

The recording heads 2301 are fixed to the print-belt-unit frame 2201. FIG. 5 illustrates a state where a single recording head 2301 is fixed to the recording-portion holding members 40a and 40b of the print-belt-unit frame 2201. Note that in FIG. 5, for facilitating the understanding of description, the recording-portion holding members 40a and 40b of the above-described print-belt-unit frame 2201 are illustrated conveniently.

As illustrated in FIG. 5, the recording head 2301 is abutted against and fixed to corresponding head fixing portions 41a and 41b. The recording head 2301 is positioned by the corresponding head fixing portions 41a and 41b. The recording head 2301 is urged toward the recording-portion holding members 40a and 40b by the body of the print module 2000 or by a pressing mechanism (not illustrated) disposed in the recording head 2301, so that the recording head 2301 is fixed so as not to move.

In this manner, in the print module 2000 of the present embodiment, the position of the recording portion 2300 that includes the recording heads 2301 is fixed by components that are other than the pressure chamber 26 and that do not move, and the position of the pressure chamber 26 can be changed. That is, the pressure chamber 26 can be moved closer to and farther from the recording portion 2300 whose position is fixed. In such a configuration, the pressure chamber 26 is moved closer to or farther from the recording heads 2301 by moving the pressure chamber 26 vertically. With this operation, the distance (i.e., a print gap) between the conveyance plane S1 of the conveyance belt 24 formed by the conveyance belt 24 supported by the platen 25 and the ejection plane S2 of the ejection portion 2302 of each of the recording heads 2301 is changed.

As described above, if the pressure chamber 26 is moved vertically with respect to the recording heads 2301 fixed to the print-belt-unit frame 2201, the print gap is adjusted. If the print gap is adjusted into a predetermined distance, the ink ejected from each recording head 2301 adheres to a constant area of the surface of the sheet S even if the thickness of the sheet S varies. As a result, the size of one dot of an image formed on the sheet surface becomes more constant. That is, a high quality image is formed on the sheet S regardless of the thickness of the sheet S, by adjusting the print gap into a proper distance in accordance with the thickness of the sheet S. In addition, since the sheet S does not contact the recording heads 2301 when conveyed by the conveyance belt 24, image defects and failure caused by the sheet S contacting the recording heads 2301 can be prevented.

### Print-Gap Adjusting Mechanism

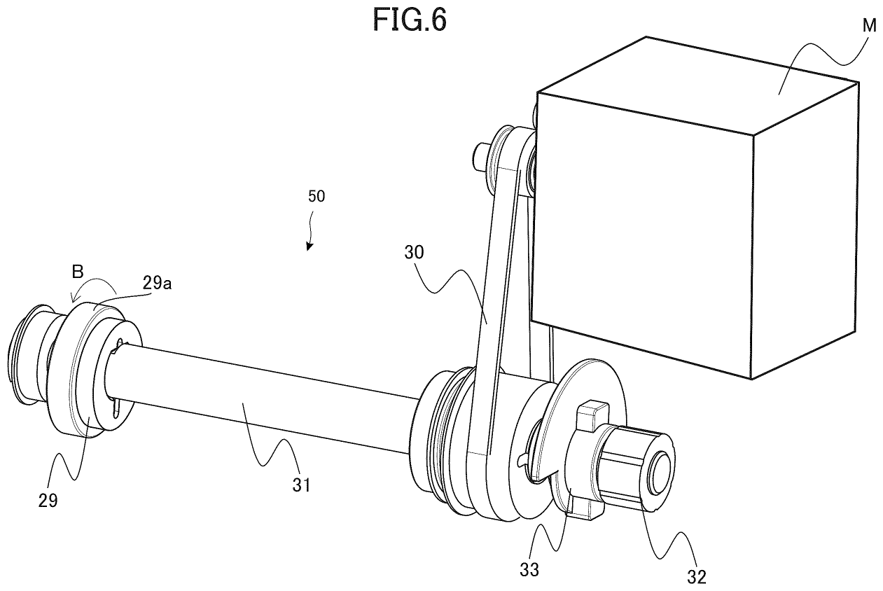

In the present embodiment, for moving the pressure chamber 26 so as to be moved closer to or farther from the recording heads 2301, the print belt unit 2200 includes four print-gap adjusting mechanisms 50. FIG. 6 illustrates a print-gap adjusting mechanism 50. As illustrated in FIG. 6, the print-gap adjusting mechanism 50 includes the automatic adjusting cam 29 that serves as a first adjusting member (first cam, first eccentric cam). The automatic adjusting cam 29 rotates around a central axis (i.e., a first axis) of a driving shaft 31, and includes an outer surface 29a (i.e., a first outer circumferential surface). The distance from the first axis to the outer surface 29a varies in accordance with the rotational angle around the first axis. The print-gap adjusting mechanism 50 includes, in addition to the automatic adjusting cam 29, a stepping motor M, a driving belt 30, the driving shaft 31, a one-way clutch 32, and a sensor flag 33. The stepping motor M, the driving belt 30, the driving shaft 31, and the one-way clutch 32 constitute a driving portion that drives and rotates the automatic adjusting cam 29.

The stepping motor M is a driving source that can output the driving force if supplied with electric power from a power source (not illustrated), and is disposed for rotating the automatic adjusting cam 29 attached to the driving shaft 31. The driving force from the stepping motor M is transmitted to the automatic adjusting cam 29 via the driving belt 30 and the driving shaft 31. That is, the driving force output from the stepping motor M is transmitted to the driving shaft 31 via the driving belt 30 wound around the driving shaft 31, so that the driving shaft 31 rotates. Since the automatic adjusting cam 29 is fixed to the driving shaft 31, the automatic adjusting cam 29 rotates together with the driving shaft 31 if the driving shaft 31 rotates.

The rotation direction of the stepping motor M can be changed. In this case, if the rotation direction of the stepping motor M is changed, the positional deviation may occur in the axial direction, due to the dimensional tolerance of parts that constitute the print-gap adjusting mechanism 50. As a result, the relationship between the rotation phase of the automatic adjusting cam 29 and the height of the uppermost point may change. For preventing this problem, the rotation direction of the automatic adjusting cam 29 is limited to one direction (indicated by an arrow B in the present embodiment). For this purpose, the one-way clutch 32 is disposed in the present embodiment.

Note that the automatic adjusting cam 29 receives force, via the manual adjusting cam 28 (see FIG. 4) disposed on the pressure chamber 26, caused by the self weight of the pressure chamber 26 and the tension of the conveyance belt 24 stretched around the stretching rollers 20 to 23 (the outer circumferential surface of the automatic adjusting cam 29 and the outer circumferential surface of the manual adjusting cam 28 are in contact with each other). By the force, the automatic adjusting cam 29 is caused to receive force (i.e., reverse rotational force) applied in a direction opposite to the rotation direction (indicated by the arrow B), depending on a rotation phase. If the automatic adjusting cam 29 receives the reverse rotational force, the automatic adjusting cam 29 may rotate in the reverse direction, so that the position of the pressure chamber 26 with respect to the recording heads 2301 may change unintentionally. For this reason, in the present embodiment, the rotation direction of the automatic adjusting cam 29 is limited to one direction by the one-way clutch 32, so that the automatic adjusting cam 29 is prevented from being rotated in the reverse direction by the reverse rotational force. Note that since the rotation direction of the automatic adjusting cam 29 is limited to one direction by the one-way clutch 32 in this manner, it is advantageous that the electric power is not supplied to the stepping motor M when the print-gap adjusting is not performed.

The sensor flag 33 is disposed in the driving shaft 31, and used for detecting the reference phase of the rotation phase of the automatic adjusting cam 29. For example, the reference phase is set at a rotation phase of the automatic adjusting cam 29 obtained when the manual adjusting cam 28 is located at the lowermost point or the uppermost point. In the present embodiment, the reference phase is set at a rotation phase of the automatic adjusting cam 29 obtained when the manual adjusting cam 28 is located at the lowermost point.

### Control System of Print-Gap Adjusting Mechanism

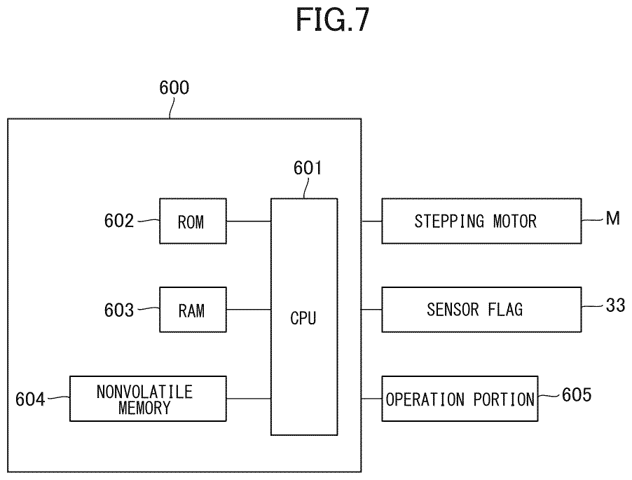

Next, the control portion 600 that controls the above-described print-gap adjusting mechanism 50 will be described with reference to FIG. 7. As illustrated in FIG. 7, the control portion 600 includes a central processing unit (CPU) 601, a read only memory (ROM) 602, and a random access memory (RAM) 603, and a nonvolatile memory 604. The control portion 600 is electrically connected with the stepping motor M and the sensor flag 33 of the print-gap adjusting mechanism 50, and with an operation portion 605 via an input/output interface, via which data can be input to and output from the control portion 600. The operation portion 605 can display various programs and various types of data, or various types of display, such as the end of an image forming job and the occurrence of an error, on a liquid crystal display portion (not illustrated). The operation portion 605 may be a touch panel that a user can operate, and can accept the start of various programs, such as an image forming job, and various types of data in accordance with a touch operation of a user.

The CPU 601 controls the print-gap adjusting mechanism 50 by executing a computer program stored in the ROM 602. The CPU 601 controls the print-gap adjusting mechanism 50, depending on an instruction from a control portion (not illustrated) that controls the whole of the image forming system 100. The RAM 603 provides a work area used by the CPU 601 for performing the process. The nonvolatile memory 604 stores various types of information necessary for controlling the print-gap adjusting mechanism 50.

The nonvolatile memory 604 stores information on the rotation phase of the automatic adjusting cam 29 that corresponds to the proper print gap (i.e., a predetermined distance). The print gap is set in a stage where the print-gap adjusting mechanism 50 is attached to the print module 2000 when the print module 2000 is assembled. The information stored in the nonvolatile memory 604 and related to the rotation phase corresponds to the number of rotations of the stepping motor M counted from the reference phase detected by the sensor flag 33. The nonvolatile memory 604 stores information on a plurality of rotation phases that correspond to the respective thicknesses of the sheet S, for each of the plurality of print-gap adjusting mechanisms 50.

For example, the information stored in the nonvolatile memory 604 and related to the rotation phase represents a rotation phase of the automatic adjusting cam 29 measured when the print gap for each color is kept at a predetermined distance in a state where the sheet S is actually sucked by the conveyance belt 24. The rotation phase of the automatic adjusting cam 29 is measured, under the above-described conditions, for each of a plurality of sheets S (regular paper sheet, thick paper sheet, and thin paper sheet) whose thickness varies, and the information on the rotation phase of the automatic adjusting cam 29 measured for each of the plurality of sheets S is stored in the nonvolatile memory 604.

Table 1 illustrates the information stored in the nonvolatile memory 604 and related to the rotation phase of the automatic adjusting cam 29.

TABLE 1

| GRAMMAGE [gsm] | NUMBER OF PULSES |
|---|---|
| 60~ | n1 |
| 106~ | n2 |
| 181~ | n3 |
| 257~ | n4 |
| 351~ | n5 |

In Table 1, the thickness of the sheet S is represented by the grammage (grams per square meter: gsm), and the information on the rotation phase of the automatic adjusting cam 29 is represented by the number of rotations of the stepping motor M that has the correlation with the rotation phase of the automatic adjusting cam 29. The number of rotations of the stepping motor M described in the present embodiment is the number of pulses (pulses per second: PPS) of the pulse signal used by the CPU 601 for controlling the stepping motor M. Note that the information that represents the thickness of the sheet S may be a type of the sheet S (such as A4, B4, or B3) or a grammage of the sheet S.

By referring to the above-described Table 1, the CPU 601 determines the number of pulses that corresponds to a grammage of the sheet S. At a timing at which the reference phase is detected by the sensor flag 33, the CPU 601 rotates the stepping motor M by the number of pulses determined by the CPU 601. With this operation, the automatic adjusting cam 29 rotates by a phase that corresponds to the number of pulses, and the rotation phase of the automatic adjusting cam 29 is controlled. The pressure chamber 26 is moved closer to or farther from the recording heads 2301 in accordance with the rotation phase of the automatic adjusting cam 29. Thus, the print gap can be adjusted into a predetermined distance (e.g., 1.38 mm) by controlling the rotation phase of the automatic adjusting cam 29.

In the present embodiment, the automatic adjusting cam 29 (i.e., a first adjusting member) abuts against the manual adjusting cam 28 that serves as a second adjusting member disposed on the pressure chamber 26 (i.e., a movable member). The abutment position between the automatic adjusting cam 29 and the manual adjusting cam 28 changes in accordance with the rotation of the automatic adjusting cam 29, so that the pressure chamber 26 moves together with the manual adjusting cam 28 and the print gap is adjusted. In other words, the automatic adjusting cam 29 (i.e., a first adjusting member) adjusts the print gap by moving so that the abutment position between the automatic adjusting cam 29 and the manual adjusting cam 28 changes.

Conventionally, the automatic adjusting cam 29 is directly in contact with the pressure chamber 26 so that the pressure chamber 26 on which the manual adjusting cam 28 is not disposed is moved closer to or farther from the recording portions 2300 by rotating the automatic adjusting cam 29. In this case, for adjusting the print gap with high accuracy in accordance with the rotation of the automatic adjusting cam 29, when the print module 2000 is assembled, the pressure chamber 26 is movably attached to the print module 2000 after the print-gap adjusting mechanism 50 is properly attached to the print module 2000.

However, in each print module 2000, the attachment position of the print-gap adjusting mechanism 50 may vary due to the tolerance of parts. In this case, the print gap may not be set at a predetermined distance in some print modules 2000. In such a print module 2000, even if the print-gap adjusting mechanism 50 is operated in accordance with the thickness of the sheet S, it may be difficult to make the distance from the ejection plane S2 of the ejection portion 2302 to the sheet surface constant, regardless of the thickness of the sheet S. In this case, if the print-gap adjusting mechanism 50 is strictly properly attached to the print module 2000, it takes time for a worker to perform the work, so that the efficiency of the assembling work may deteriorate.

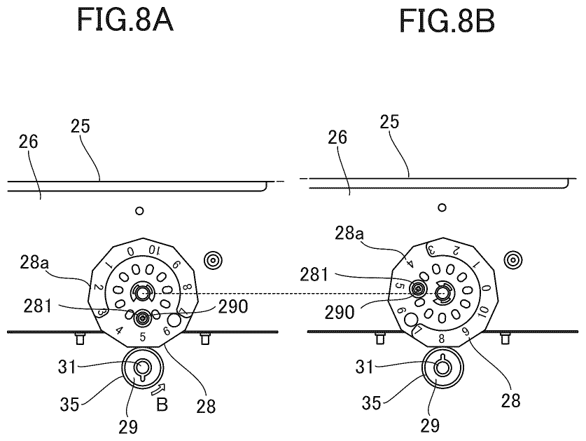

In view of the above-described problems, in the present embodiment, the manual adjusting cam 28 is disposed on the pressure chamber 26 for allowing a worker to easily attach the pressure chamber 26, when the print module 2000 is assembled, to the print module 2000 at a position at which the print-gap adjusting is properly performed by the print-gap adjusting mechanism 50. Hereinafter, a plurality of manual adjusting cams 28 disposed on the pressure chamber 26 will be described with reference to FIGS. 8A and 8B, while referring to FIGS. 2 and 4.

As illustrated in FIG. 4, each of the manual adjusting cams 28 that serves as a second adjusting member (second cam, second eccentric cam) is disposed on a corresponding side wall portion of the pressure chamber 26, on the plurality of negative-pressure generating units 27 side (i.e., on the lower side of the pressure chamber 26) (the plurality of negative-pressure generating units 27 is disposed in the print-belt-unit frame 2201). The pressure chamber 26 moves vertically in the print-belt-unit frame 2201 in accordance with the rotation of the automatic adjusting cams 29 in a state where each of the manual adjusting cams 28 is constantly in contact with a corresponding one of the automatic adjusting cams 29 of the plurality of print-gap adjusting mechanisms 50. That is, the automatic adjusting cams 29 serve as a driver, and the pressure chamber 26 on which the manual adjusting cams 28 are disposed serves as a follower.

As illustrated in FIGS. 8A and 8B, the manual adjusting cam 28 is an eccentric cam that has its outer circumferential surface in which a plurality of linear outer surfaces 28a is linearly formed. In the manual adjusting cam 28, the distance from the center of rotation to the linear outer surfaces 28a are different from each other. Note that in FIGS. 8A and 8B, only one of eleven linear outer surfaces 28a is given the symbol. The distance from the center of rotation to one linear outer surface 28a is different from the distance from the center of rotation to another linear outer surface 28a adjacent to the one linear outer surface 28a, and difference between the distance from the center of rotation to the one linear outer surface 28a and the distance from the center of rotation to the adjacent linear outer surface 28a is in a range from about 0.05 mm to about 0.1 mm. For example, in a case where the manual adjusting cam 28 has eleven linear outer surfaces 28a and the distance from the center of rotation to the eleven linear outer surfaces 28a is changed in steps of 0.1 mm, the pressure chamber 26 can be moved vertically in a range of 1.0 mm (±0.5 mm) in accordance with the rotation of the manual adjusting cam 28.

That is, the manual adjusting cam 28 rotates around a second axis different from the axis (i.e., a first axis) of the automatic adjusting cam 29, and includes a second outer circumferential surface (i.e., the plurality of linear outer surfaces 28a). In addition, the distance from the second axis to the second outer circumferential surface varies in accordance with the rotational angle around the second axis. In addition, in the present embodiment, at least a portion of the outer circumferential surface of the manual adjusting cam 28 has a polygonal shape, when viewed from the direction of the second axis, that includes a plurality of sides having distances from the second axis to one side different from each other.

On the surface of the manual adjusting cam 28, scale marks of 0 to 10 are printed at positions that correspond to the plurality of linear outer surfaces 28a. Thus, if a worker visually checks the scale marks, the worker can check how much the worker has moved the pressure chamber 26 vertically. For example, if the rotation of the manual adjusting cam 28 illustrated in FIG. 8A is started in a state where a linear outer surface 28a that has a scale mark of 5 is in contact with the automatic adjusting cam 29, and the manual adjusting cam 28 is rotated clockwise in steps of one increment (the scale mark of the linear outer surface 28a that is in contact with the automatic adjusting cam 29 is changed from 5 toward 10), the pressure chamber 26 moves upward in steps of 0.1 mm (see FIG. 8B). In contrast, if the rotation of the manual adjusting cam 28 is started in a state where a linear outer surface 28a that has a scale mark of 5 is in contact with the automatic adjusting cam 29, and the manual adjusting cam 28 is rotated counterclockwise in steps of one increment (the scale mark of the linear outer surface 28a that is in contact with the automatic adjusting cam 29 is changed from 5 toward 0), the pressure chamber 26 moves downward in steps of 0.1 mm. In this manner, the pressure chamber 26 is moved vertically in steps of 0.1 mm by a worker manually operating the manual adjusting cam 28, so that the print gap is set at a predetermined distance when the print module 2000 is assembled.

In addition, in the manual adjusting cam 28, a fixing hole 281 is formed at a position separated from the center of rotation, for fixing a fixing member 290 such as a screw. The manual adjusting cam 28 is fixed to the pressure chamber 26 by the fixing member 290 so as not to move, in a state where any one of the eleven linear outer surfaces 28a is in contact with the automatic adjusting cam 29. FIG. 8A illustrates a state where a linear outer surface 28a of the manual adjusting cam 28 that has a scale mark of 5 is in contact with the automatic adjusting cam 29. FIG. 8B illustrates a state where a linear outer surface 28a of the manual adjusting cam 28 that has a scale mark of 8 is in contact with the automatic adjusting cam 29.

As illustrated in FIG. 4, the print-belt-unit frame 2201 includes a first opening portion 42 and a second opening portion 43 formed for positioning the pressure chamber 26 when the pressure chamber 26 is attached to the interior of the print-belt-unit frame 2201. The second opening portion 43 is formed at four positions that correspond to the four manual adjusting cams 28, so that at least a portion of each of the manual adjusting cams 28 of the pressure chamber 26 is inserted into the second opening portion 43. The automatic adjusting cam 29 is disposed below the second opening portion 43 so that the automatic adjusting cam 29 contacts a linear outer surface 28a (see FIG. 8A) of the manual adjusting cam 28, which is a portion of the manual adjusting cam 28 that is exposed from the second opening portion 43 into which the manual adjusting cam 28 has been inserted. On the bottom surface of the pressure chamber 26, a projection portion 44 that projects downward is formed. The projection portion 44 is inserted into the first opening portion 42. When the print module 2000 is assembled, the projection portion 44 is inserted into the first opening portion 42, and at least a portion of the manual adjusting cam 28 is inserted into the second opening portion 43. With this operation, the pressure chamber 26 is disposed at a predetermined position in the print-belt-unit frame 2201.

The projection portion 44 inserted in the first opening portion 42 functions also as a guide member when the pressure chamber 26 moves vertically. That is, when the pressure chamber 26 is moved vertically by the rotation of the automatic adjusting cam 29, the pressure chamber 26 is guided by the projection portion 44 inserted in the first opening portion 42. In this manner, the moving direction of the pressure chamber 26 is limited to a direction in which the pressure chamber 26 is moved toward and away from the recording heads 2301. Thus, the sheet surface (i.e., a surface to be applied with ink) and the recording heads 2301 are moved closer or farther relative to each other by the rotation of the automatic adjusting cam 29, without deviating a position on the sheet to which the ink is to be ejected.

When assembling the print module 2000, a worker sets the rotation phase of the four automatic adjusting cams 29 of the print-gap adjusting mechanisms 50 that have already been attached to the print module 2000, at the reference phase, and after that, temporarily attaches the pressure chamber 26 to the print-belt-unit frame 2201. For example, the pressure chamber 26 is temporarily attached to the print-belt-unit frame 2201 in a state where the manual adjusting cam 28 has been adjusted so that a linear outer surface 28a of the manual adjusting cam 28 that has a scale mark of 5 contacts the automatic adjusting cam 29. In a state where the pressure chamber 26 is temporarily attached to the print-belt-unit frame 220, the amount of deviation between the reference position at which the conveyance plane S1 of the conveyance belt 24 is required to be positioned and an actual position of the conveyance plane S1 of the conveyance belt 24 is measured from the outside, by using a laser displacement meter or the like.

Then the worker temporarily removes the pressure chamber 26 from the print-belt-unit frame 2201, and manually rotates the manual adjusting cam 28 clockwise or counterclockwise in accordance with the amount of deviation from the reference position, which has been measured by using the laser displacement meter. The deviation from the reference position is reduced by rotating the manual adjusting cam 28. Then the worker fixes the manual adjusting cam 28, which has been rotated to an appropriate position in the scale so that the deviation is reduced and that the actual conveyance plane S1 of the conveyance belt 24 is positioned at the reference position, to the pressure chamber 26 so as not to rotate, by using the fixing member 290. That is, the manual adjusting cam 28 is fixed to the pressure chamber 26 by the fixing member 290 so that the manual adjusting cam 28 (i.e., a second adjusting member) is immovable after the pressure chamber 26 (i.e., a movable member) is assembled to the image forming apparatus. Then the worker reattaches the pressure chamber 26 to the print-belt-unit frame 2201.

Thus, the manual adjusting cam 28 of the pressure chamber 26 is rotated by a worker, so that the pressure chamber 26 attached to the print-belt-unit frame 2201 is moved vertically with respect to the automatic adjusting cam 29. In other words, the manual adjusting cam 28 (i.e., a second adjusting member) is moved so that the position of the pressure chamber 26 (i.e., a movable member) with respect to the abutment position between the automatic adjusting cam 29 and the manual adjusting cam 28 changes, so that the print gap can be adjusted. With this operation, the deviation in the assembly position that may be produced, due to the tolerance of parts, in the print-gap adjusting mechanism 50 that has already been attached to the print-belt-unit frame 2201 can be reduced by changing the position of the pressure chamber 26 by rotating the manual adjusting cam 28. In this manner, the print gap is adjusted into a predetermined distance in the assembled print module 2000.

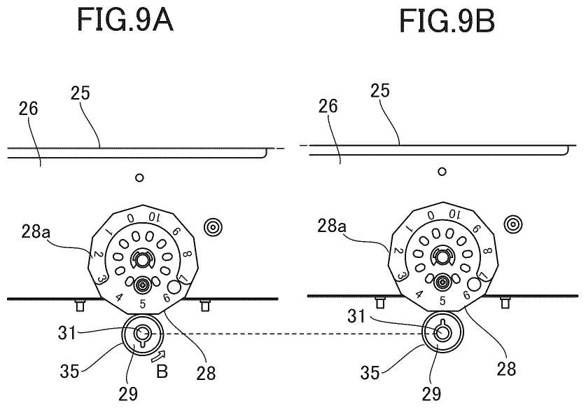

Next, the print-gap adjusting performed by the automatic adjusting cam 29 of the print-gap adjusting mechanism 50 will be described with reference to FIGS. 9A and 9B, while referring to FIG. 2. FIG. 9A illustrates a state where the pressure chamber 26 is most distant from the recording heads 2301 by the operation of the print-gap adjusting mechanism 50. FIG. 9B illustrates a state where the pressure chamber 26 is moved closest to the recording heads 2301 by the operation of the print-gap adjusting mechanism 50. Note that the pressure chamber 26 is held in a state where a linear outer surface 28a of the manual adjusting cam 28 with a scale mark of ‘5’ is in contact with the automatic adjusting cam 29.

As illustrated in FIGS. 9A and 9B, the automatic adjusting cam 29 rotates around the driving shaft 31. The center of the automatic adjusting cam 29 and the center of rotation of the driving shaft 31 are shifted from each other by a predetermined amount of deviation. The automatic adjusting cam 29 is press-fit into a bearing 35, and the center of rotation of the automatic adjusting cam 29 (or the center of rotation of the driving shaft 31) and the center of the bearing 35 are shifted from each other by a value which is equal to the amount of deviation between the center of the automatic adjusting cam 29 and the center of rotation of the driving shaft 31. In such a configuration, if the automatic adjusting cam 29 is rotated by the rotation of the driving shaft 31, the manual adjusting cam 28 is moved upward or downward. As a result, the pressure chamber 26 is moved vertically with respect to the recording heads 2301. That is, the automatic adjusting cam 29 (i.e., a first adjusting member) moves the pressure chamber 26 (i.e., a movable member) in a state where the manual adjusting cam 28 (i.e., a second adjusting member) is fixed by the fixing member 290.

In the present embodiment, the shape of the automatic adjusting cam 29 is set so that if the rotation of the automatic adjusting cam 29 is started in a state where the pressure chamber 26 is most distant from the recording heads 2301 (FIG. 9A) and the automatic adjusting cam 29 is rotated by 180 degrees, the pressure chamber 26 is moved closest to the recording heads 2301 (FIG. 9B). The amount of displacement of the pressure chamber 26, and the relationship between the rotational angle and the position of the pressure chamber 26 can be set by the shape of the automatic adjusting cam 29. In addition, the range of movement of the pressure chamber 26 is adjusted by the amount of deviation between the center of rotation of the automatic adjusting cam 29 (or the center of rotation of the driving shaft 31) and the center of the bearing 35. That is, the amount of displacement between the position of the pressure chamber 26 in a state illustrated in FIG. 9A and the position of the pressure chamber 26 in a state illustrated in FIG. 9B is determined by the amount of deviation between the center of rotation of the automatic adjusting cam 29 (or the center of rotation of the driving shaft 31) and the center of the bearing 35.

In the present embodiment, the amount of displacement of the pressure chamber 26 caused by the manual adjusting cam 28 in accordance with the amount of rotation of the manual adjusting cam 28 is larger than that caused by the automatic adjusting cam 29 in accordance with the amount of rotation of the automatic adjusting cam 29. For achieving this, the shape of the manual adjusting cam 28 and the shape of the automatic adjusting cam 29 are set. In other words, the adjustable range of the print gap in a case where the manual adjusting cam 28 (i.e., a second cam) is rotated while the rotation phase of the automatic adjusting cam 29 (i.e., a first cam) is fixed is larger than the adjustable range of the print gap in a case where the automatic adjusting cam 29 (i.e., a first cam) is rotated while the rotation phase of the manual adjusting cam 28 (i.e., a second cam) is fixed. The adjustable range of the print gap is equal to the maximum value in the amount of displacement of the pressure chamber 26 determined by the rotation of the automatic adjusting cam 29 (i.e., a first cam) or the maximum value in the amount of displacement of the pressure chamber 26 determined by the rotation of the manual adjusting cam 28 (i.e., a second cam).

By the way, there is a case where the amount of deviation in the attachment position of the print-gap adjusting mechanism 50 caused by the tolerance of parts is larger than the amount of adjustment required in accordance with the thickness of the sheet S. In this case, for correcting the deviation in the attachment position, the pressure chamber 26 may be moved more by the manual adjusting cam 28 than by the automatic adjusting cam 29.

As described above, in the present embodiment, the manual adjusting cam 28 (i.e., a second adjusting member) is disposed in addition to the automatic adjusting cam 29 (i.e., a first adjusting member) of the print-gap adjusting mechanism 50. Thus, the distance from the ejection plane S2 of the recording heads to the conveyance plane S1 of the conveyance belt 24 can be adjusted more properly.

In addition, the manual adjusting cam 28 is disposed on the pressure chamber 26, and the pressure chamber 26 is disposed so as to be able to move vertically in a state where the manual adjusting cam 28 is in contact with the automatic adjusting cam 29. Since the position of the pressure chamber 26 changes in accordance with the rotation of the manual adjusting cam 28, the deviation in the assembly position that may occur in the print-gap adjusting mechanism 50, which has already been attached to the print module 2000, due to the tolerance of parts is reduced. As a result, the print gap is adjusted into a predetermined distance. Since the print gap is adjusted into a predetermined distance in the print module 2000, the distance from the ejection plane S2 of the ejection portion 2302 to the sheet surface can be made closer to a proper value regardless of the thickness of the sheet S, for example, in a case where the print-gap adjusting mechanism 50 is operated based on the thickness of the sheet S in the image forming job. In this manner, in a case where the automatic adjusting cam 29 is operated, the proper adjustment of the distance between the ejection plane S2 of the ejection portion 2302, which ejects ink to the sheet S, and the outer circumferential surface 24a of the conveyance belt 24, which conveys the sheet S, can be easily achieved by adjusting the manual adjusting cam 28.

### OTHER EMBODIMENTS

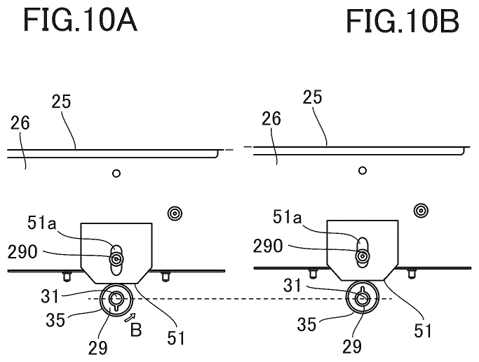

In the above-described embodiment, the eccentric cam is used as the manual adjusting cam 28 of the pressure chamber 26. However, the present disclosure is not limited to this. For example, a slide plate 51 illustrated in FIGS. 10A and 10B and serving as a slide member may be used as the manual adjusting member disposed on the pressure chamber 26. The slide plate 51 that serves as a second adjusting member is disposed on the pressure chamber 26 so as to be able to slide in a direction in which the pressure chamber 26 is moved closer to and farther from the recording heads 2301. In the slide plate 51, a long hole 51a is formed, elongated in a direction in which the pressure chamber 26 is moved closer to and farther from the recording heads 2301. Thus, the slide plate 51 can be fixed such that the relative position of the long hole 51a to the fixing member 290, such as a screw, can be changed. In other words, the long hole 51a is formed in the slide plate 51 in a direction in which the conveyance belt 24 is moved closer to and farther from the recording heads 2301, the slide plate 51 is fixed to the pressure chamber 26 via the fixing member 290 inserted in the long hole 51a, and the position of the slide plate 51 with respect to the pressure chamber 26 can be changed in accordance with the position of the fixing member 290 with respect to the long hole 51a.

The bottom surface of the slide plate 51 is in contact with the automatic adjusting cam 29. The slide plate 51 is moved vertically with respect to the pressure chamber 26, so that the above-described deviation from the reference position can be reduced. Although not illustrated in FIGS. 10A and 10B, a scale may be printed along the long hole 51a on the surface of the slide plate 51, for allowing a worker to visually check how much the worker has moved the pressure chamber 26 vertically.

In the above-described embodiment, four manual adjusting cams 28 are disposed at four positions of the pressure chamber 26, as an example. However, the present disclosure is not limited to this. For example, the manual adjusting cams 28 may be disposed outside the side wall portions of the pressure chamber 26 in the width direction, and at positions that correspond to the plurality of recording heads 2301, disposed in the conveyance direction, when the print module 2000 is viewed from the width direction. For example, in a case where the recording portion 2300 includes five recording heads 2301 as illustrated in FIG. 2, five manual adjusting cams 28 are disposed on each side wall portion along the conveyance direction, at the same positions in the conveyance direction. If the manual adjusting cams 28 are disposed in this manner, at the positions that correspond to the plurality of recording heads 2301, the influence on the print gap by the self weight of each of the recording heads 2301 can be reduced.

In the above-described embodiment, the automatic adjusting cam 29 is driven by the stepping motor M or the like. However, the present disclosure is not limited to this. For example, a cam (i.e., the manual adjusting cam 28) manually operated by a worker in the above-described embodiment may be driven and automatically rotated by the stepping motor M or the like. In this case, a cam (i.e., the automatic adjusting cam 29) driven by the stepping motor M or the like in the above-described embodiment is rotated by a worker manually operating the cam.

In the present disclosure, since the first adjusting member and the second adjusting member are included, the distance from the ejection plane of the recording heads to the conveyance plane of the conveyance belt that conveys the sheet can be adjusted more properly. In addition, in the present disclosure, the distance from the ejection plane to the conveyance plane is adjusted in advance by the second adjusting member, and after that, the first adjusting member is operated in accordance with the thickness of the sheet. As a result, the distance from the ejection plane to the sheet surface can be set closer to a proper value, regardless of the thickness of the sheet.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-191567, filed Oct. 31, 2024, which is hereby incorporated by reference herein in its entirety.

What is claimed is:

1. An image forming apparatus comprising:
a belt configured to convey a sheet along a conveyance plane formed by a portion of an outer circumferential surface of the belt;
a recording head disposed to face the belt, the recording head having an ejection plane at which ink is ejected from the recording head toward the sheet being conveyed by the belt;
a movable member configured to be movable in a first direction such that the belt is moved closer to and farther from the recording head;
a first adjusting member configured to adjust a distance in the first direction between the ejection plane and the conveyance plane at a position where the belt faces the ejection plane by moving the movable member in the first direction; and
a second adjusting member disposed on the movable member, arranged to abut against the first adjusting member,
wherein the first adjusting member is configured to move such that the first adjusting member and the second adjusting member abut against each other an abutment position, and
wherein the second adjusting member is configured to adjust the distance in the first direction by changing a position of the movable member in the first direction with respect to the abutment position.

2. The image forming apparatus according to claim 1, further comprising:
a fixing member configured to fix the second adjusting member with respect to the movable member such that the second adjusting member is immovable after the movable member is assembled to the image forming apparatus,
wherein the first adjusting member is configured to move the movable member in a state where the second adjusting member is fixed by the fixing member.

3. The image forming apparatus according to claim 1, further comprising:
a plurality of rollers around which the belt are stretched; and
a frame configured to support the plurality of rollers,
wherein the recording head is fixed to the frame, and
wherein the movable member is disposed movably in the frame.

4. The image forming apparatus according to claim 3,
wherein the frame includes an opening portion into which at least a portion of the second adjusting member is inserted, and
wherein the first adjusting member is configured to contact the at least the portion of the second adjusting member exposed from the opening portion.

5. The image forming apparatus according to claim 1,
wherein the movable member is a sucking unit configured to cause the sheet to be sucked on the belt.

6. The image forming apparatus according to claim 1,
wherein the first adjusting member is a first cam configured to rotate around a first axis and including a first outer circumferential surface formed such that a distance from the first axis to the first outer circumferential surface varies in accordance with a rotational angle around the first axis.

7. The image forming apparatus according to claim 6, further comprising:
a driving portion configured to drive and rotate the first cam,
wherein the second adjusting member is configured to be operated manually by a user.

8. The image forming apparatus according to claim 7,
wherein a rotation direction of the first cam by the driving portion is limited to one direction.

9. The image forming apparatus according to claim 8,
wherein the driving portion includes:
a driving source configured to generate driving force;
a driving shaft configured to transmit the driving force from the driving source to the first cam; and
a one-way clutch disposed on the driving shaft and configured to limit the rotation direction of the first cam to the one direction.

10. The image forming apparatus according to claim 8, further comprising:
a control portion configured to control the driving portion,
wherein the control portion is configured to adjust the distance by causing the driving portion to rotate the first cam by an amount of rotation based on a thickness of the sheet.

11. The image forming apparatus according to claim 6,
wherein the second adjusting member is a second cam configured to rotate around a second axis and including a second outer circumferential surface formed such that a distance from the second axis to the second outer circumferential surface varies in accordance with a rotational angle around the second axis, and
wherein the first outer circumferential surface and the second outer circumferential surface are configured to abut against each other at the abutment position.

12. The image forming apparatus according to claim 11,
wherein an adjustable range of the distance in a case where the second cam is rotated while a rotation phase of the first cam is fixed is larger than an adjustable range of the distance in a case where the first cam is rotated while a rotation phase of the second cam is fixed.

13. The image forming apparatus according to claim 12,
wherein at least a portion of the second outer circumferential surface has a polygonal shape that includes a plurality of sides having different distances from the second axis when viewed in a direction along the second axis.

14. The image forming apparatus according to claim 13,
wherein the second cam is configured to be fixed to the movable member so as not to rotate, in a state where any one of the plurality of sides is in contact with the first outer circumferential surface.

15. The image forming apparatus according to claim 6,
wherein the second adjusting member is a slide member configured to slide in a direction in which the belt is moved closer to and farther from the recording head.

16. The image forming apparatus according to claim 15,
wherein the slide member is (i) provided with a long hole elongated in a direction in which the belt is moved closer to and farther from the recording head, (ii) fixed to the movable member by a fixing member inserted in the long hole, and (iii) configured such that a position of the slide member with respect to the movable member is changed in accordance with a position of the fixing member with respect to the long hole.
